(19) United States
(12) Patent Application Publication
(10) Pub. No.: US 2004/0067291 A1
(43) Pub. Date: Apr. 8, 2004

(54) Chicken skin chips, and/or chicken chips/skins

(76) Inventors: Derek Brian Crawford, Jonesboro, GA (US); Ronnie Lee Crawford, Jonesboro, GA (US)

Correspondence Address: DEREK BRIAN CRAWFORD, PO BOX 742203, RIVERDALE, GA, 30274, US

(21) Appl. No.: 10/266,148

(22) Filed: Oct. 8, 2002

(51) Int. Cl. A23L 1/00

(52) U.S. Cl. 426/438

(57) ABSTRACT

A deep-fried and crunchy product is prepared by using 100% chicken-skin stripped parts, cutting the stripped chicken-skin parts to small pieces, deep-frying the chicken-skin stripped parts. The chicken-skin stripped parts must have an average dimension of 3 inches or less to ensure proper puffing to crunchy brittleness.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

There is no immediate background of this invention. A snack food which is similar to “chicken skin chip”, was a solid product called “crackling” resulting from a conventionally practiced rendering processes. Hog fat or lard is rendered by applying heat to melt the fat to drive out of the tissue. After the melted fat is drained away, the remaining solid portions of the tissue are compressed, while hot, to squeeze out additional fat. This solid, compressed product of non-fat tissue is called “cracklings” because of the brittle nature of that product.

### BRIEF SUMMARY OF THE INVENTION

Chicken Skin Chips are made of natural chicken skin. This product will be composed with or without various flavoring spices, then baked or deep-fried.

The spice flavoring variety would include but not be limited to; Hot Wing, Spicy, Sweet & Sour, Garlic, Barbecue, Low Fat, Regular, Teriyaki, Honey Mustard, Fried, Baked, Caribbean flavorings etc.

The texture of the final product is brittle & crunchy but not hard, able to be consumed as a snack food by humans.

### BRIEF DESCRIPTION OF THE SEVERAL VIEWS OF THE DRAWING

Not Applicable

### DETAILED DESCRIPTION OF THE INVENTION

Chicken Skin Chips are made of natural chicken skin. Processing entail cutting the chicken skin parts to have an average dimension of 1 through 3 inches.

The prepared chicken skin parts are to be washed thoroughly then seasoned according to the taste proposed for batch process. Main ingredients to be included selectively are: salt, monosodium glutamate (flavor enhancer), paprika, onion, dextrose silicon dioxide, partially hydrogenated soybean and cottonseed oil, autolyzed yeast torula yeast, garlic, artificial flavor, and spice extractives.

The spicing flavoring will consist of variety which would include but not be limited to; Original, Hot Wing, Spicy, Sweet & Sour, Garlic, Barbecue, Low Fat, Regular, Teriyaki, Honey Mustard, Fried, Baked, and Caribbean flavorings.

Then the cooking process of the cut, cleaned and special seasoned prepared chicken skin parts is to deep-fry in vat of fat or peanut oil and/or vegetable oil at temperatures between 350 degree F. and 450 degree F. until the moisture content of the chicken skin part is evaporated and the chicken skin part has puffed to crunchy brittle. Also the cut, cleaned and special seasoned prepared chicken skin parts can be bake in forced hot-air oven at temperatures between 350 degree F. and 450 degree F. until the moisture content of the chicken skin part is evaporated and the chicken skin part has puffed to crunchy brittle.

The puffed crunchy brittle chicken skin part is completed by air-drying at temperatures up to 250. degree. F. Once dried, the chicken skin chip could then be packaged. Packaging the product in vacuum-sealed containers will help to preserve the product until consumption.

What is claimed is:

1. A method for producing a deep-fried and crunchy product from chicken skin parts:
(a) wherein providing a starting material, which is comprised of 100% percent chicken skin parts.

2. The method of claim is wherein cutting the chicken skin parts to have an average dimension of 1 through 3 inches.

3. The method of claim is wherein frying the cut, cleaned and seasoned prepared chicken skin parts in fat or peanut oil and/or vegetable oil at temperatures between 350.degree. F. and 450. degree. F until the moisture content of the chicken skin part is evaporated and the chicken skin part has puffed to crunchy brittle.

4. The method of claim is wherein drying the puffed crunchy brittle chicken skin part is mainly done by air-drying at temperatures up to 250. degree. F.
